(19) United States
(12) Patent Application Publication
(10) Pub. No.: US 2011/0262058 A1
(43) Pub. Date: Oct. 27, 2011

(54) Air-bearing slide platform having positioning module

(75) Inventors: Gao-Heng Lin, Taichung City (TW); Cheng-Feng Lin, Taichung City (TW); Kou-I Szu, Taichung City (TW)

(73) Assignee: Hiwin Mikrosystem Corp.

(21) Appl. No.: 12/799,502

(22) Filed: Apr. 26, 2010

(51) Int. Cl. F16C 32/06

(52) U.S. Cl. 384/12

(57) ABSTRACT

An air-bearing slide platform having a positioning module includes: at least one slide guide, a carrier mounted on the slide guide, at least one first air bearing provided between an upper surface of the slide guide and the carrier, and the positioning module provided on the slide platform. The air-bearing slide platform is characterized in that the positioning module includes a pair of ramps formed at two lower sides of the slide guide, and at least one second air bearing provided between two extended lower sides of the carrier and the ramps.

### BACKGROUND OF THE INVENTION

1. Technical Field

The present invention relates to slide platforms implementing air-bearing devices, and more particularly, to an air-bearing slide platform having a positioning module and applicable to heavy-duty, frictionless, high-preciseness machining centers and testing apparatuses to provide accurate positioning effect.

2. Description of Related Art

With the vigorous development of automation industries, machining centers have been extensively used. In machining centers, linear guideways are indispensable for parts of machining centers to perform displacement. Currently, conventional linear guideways typically use slider bearings or roller bearings for driving sliding parts to slide on the linear guideways.

The guideways now used in precision manufacturing machines are most boxways and linear guideways for meeting the requirements of heavy duty and high preciseness. However, boxways having considerable friction suffer from the problem of stick slip in low-speed operation and of high heat as well as temperature rise in high-speed operation. The considerable friction also results in quick wear. In addition, high friction is unfavorable to machining accuracy of machines. For reducing friction, lubrication is applied to boxways. However, the lubricant, when getting cooled, can condense on the boxways and make the boxways need frequent maintenance and clean. Thus, such a solution is disadvantageous for the high maintenance cost in addition to oil vapor pollution.

In view of this, industrially, slider bearings and roller bearings have been gradually substituted by air bearings so as to eliminate the problems in the traditional guideways related to contact. Nevertheless, the existing guideways adopting air bearings usually tend to swing in high-speed operation.

### SUMMARY OF THE INVENTION

In view of the shortcomings of the prior-art devices, the present invention herein provides an air-bearing slide platform having a positioning module.

The air-bearing slide platform of the present invention includes: at least one slide guide, a carrier mounted on the slide guide, at least one first air bearing provided between an upper surface of the slide guide and the carrier, and the positioning module provided on the slide platform, the air-bearing slide platform being characterized in that the positioning module includes a pair of ramps formed at two lower sides of the slide guide, and at least one second air bearing provided between two extended lower sides of the carrier and the ramps.

One objective of the present invention is to use the second air bearings working with the ramps of the slide guide to enable the slide platform to bear loads coming vertically and horizontally, thereby achieving precise positioning.

Another objective of the present invention is to eliminate contact between the first air bearings and the slide guide, so as to avoid the problem of stick slip that otherwise appears because of friction, and in turn prevent high heat that otherwise happens in high-speed operation, thereby enhancing accuracy of a machining device using the air-bearing slide platform.

Another objective of the present invention is to eliminate contact between the first air bearings and the slide guide, so as to eliminate the need of lubrication on the slide guide that is otherwise required due to friction and lengthen the service life of the components, thereby reducing maintenance costs.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of an illustrative embodiment when read in conjunction with the accompanying drawings, wherein:

FIG. 1 is a perspective view of an air-bearing slide platform having a positioning module wherein a linear motor is used as its power source according to the present invention;

FIG. 2 is an exploded view of the air-bearing slide platform of FIG. 1;

FIG. 3 is a cross-sectional view of the air-bearing slide platform of FIG. 1;

FIG. 4 is a schematic drawing showing a first air bearing according to the present invention; and

FIG. 5 is a schematic drawing showing a second air bearing interacting with ramps of the present invention.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made in scale.

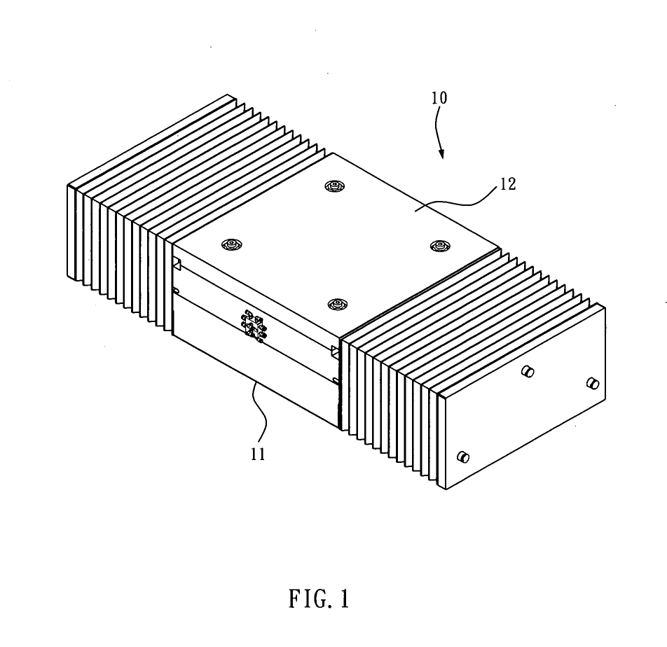

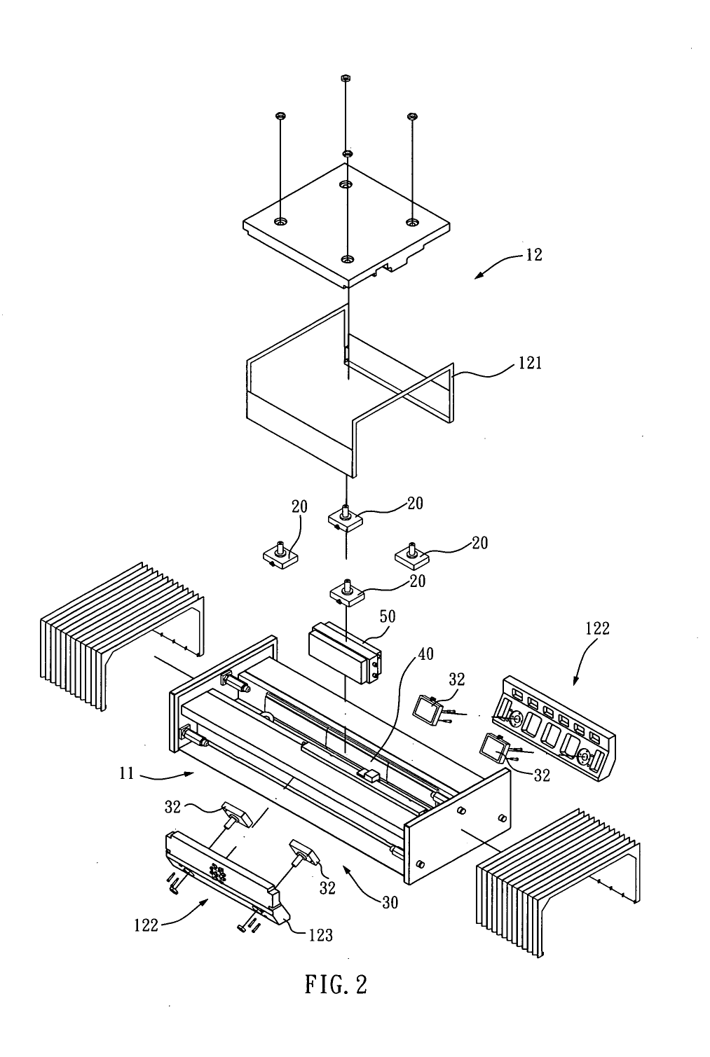

Referring to FIGS. 1 and 2, the present invention is an air-bearing slide platform having a positioning module; it is primarily composed of a slide platform 10, at least one first air bearing 20, and a positioning module 30.

The slide platform 10 includes a slide guide 11 and a carrier 12. Therein, the carrier 12 further has a frame 121 and two connecting seats 122. The frame 121 has two sides extending downward and spraddles on the slide guide 11 so the two sides of the frame 121 are adjacent to two sides of the slide guide 11. The connecting seats 122 are arranged at the two sides of the frame 121 and each have an inclined portion 123.

The first air bearings 20, as shown in the drawings, are provided between an upper surface of the slide guide 11 and the carrier 12, so that the first air bearings 20 are positioned above but not in contact with the slide guide 11.

The positioning module 30 includes a pair of ramps 31 and at least one second air bearing 32. The two ramps 31 are formed at two lower sides of the slide guide 11, respectively. The second air bearings 32, as shown in the drawings, are provided between the connecting seats 122 flanking the frame 121 and the ramps 31. Therein, the two ramps 31 are arranged symmetrically and mutually approaching so as to define a narrow-bottom trapezoid therebetween. The inclined portions 123 of the connecting seats 122 are matching to the ramps 31 so that the second air bearings 32 settled on the inclined portions 123 correspond to the ramps 31, respectively, wherein an acting surface of each said second air bearing 32 is parallel to the corresponding ramps 31.

In the embodiment of the present invention, as illustrated in FIGS. 1 through 3, a linear motor is used as a power source. The linear motor has two stators 40 settled at two inner laterals of the slide guide 11. A mover 50 is settled between the stators 40 and fixedly connected with the carrier 12, so that when the stators 40 make the mover 50 move, the carrier 12 is driven to slide on the slide guide 11. Despite the above description, any known principle of linear motors may be used with the present invention without limitation and no further discussion would be given herein.

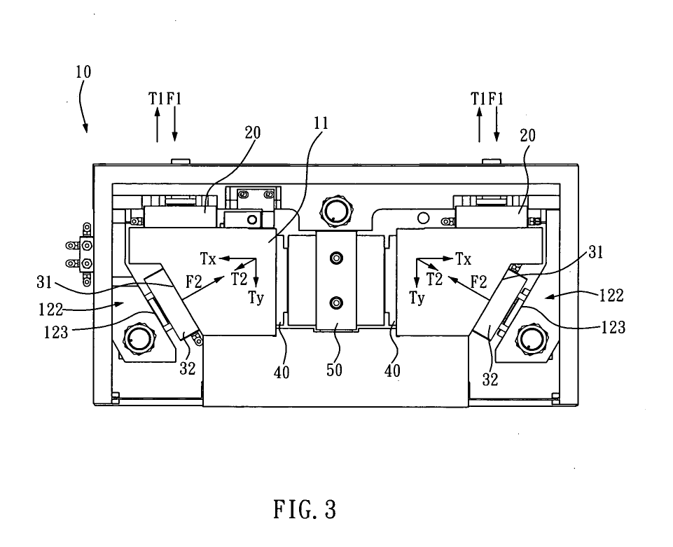

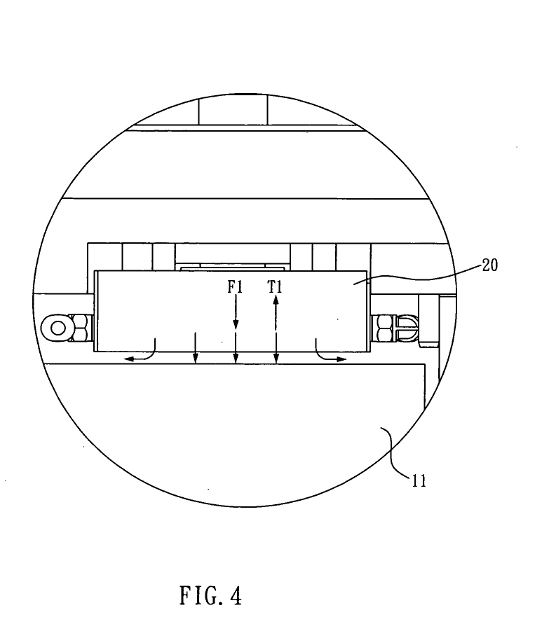

In use, referring to FIG. 3 and FIG. 4, compressed air is introduced into axial chambers of the first air bearings 20 and the second air bearings 32, the first air bearings 20 give downward air flows to the slide guide 11, so as to float the carrier 12. Thereby, without contact between the first air bearings 20 and the slide guide 11, the carrier 12 is allowed to slide along the slide guide 11 on the strength of the driving force generated by the mover 50 and the stators 40. Despite the above description, any known principle of air bearings may be used with the present invention without limitation and no further discussion would be given herein.

The downward air flows of the first air bearings 20 each forms a gas pressure F₁ that incurs an upward counterforce T₁. However, since the first air bearings 20 between the slide guide 11 and the carrier 12 tend to be affected by the compressed air or other external forces and vibrate, for preventing displacement of the slide platform 10 and the mover 50, the positioning module 30 is provided to facilitate positioning.

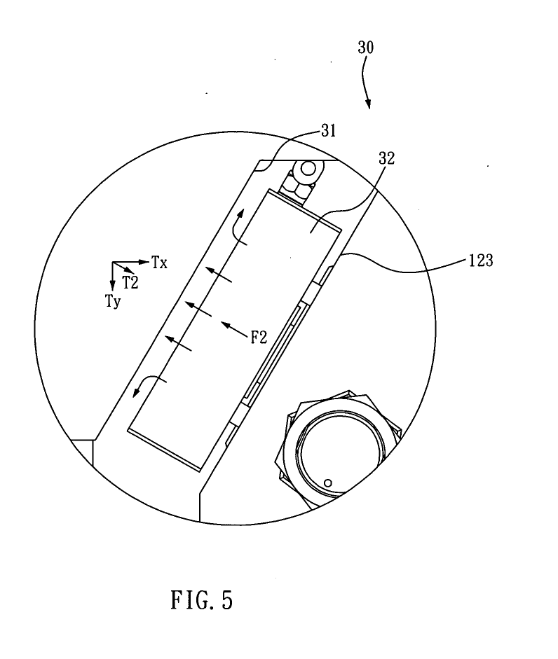

Referring to FIG. 5, each said second air bearing 32 gives a bias upward air flow to the slide guide 11 and thus interacts with the corresponding ramp 31 without contact. The bias upward air flows of the second air bearing 32 each forms a gas pressure F₂ that incurs a bias downward counterforce T₂. At this time, the bias downward counterforce T₂ generates a horizontal component Tx and a vertical component Ty. Thereby, the horizontal components Tx at the two sides of the slide platform 10 counterbalance each other and the vertical components Ty at the two sides of the slide platform 10 counterbalance the counterforce T₁ generated by the first air bearing 20, so that the slide platform 10 is well positioned vertically and horizontally.

When the subject matter of the present invention is applied to a high-preciseness machining device, the positioning module 30 effectively positions the slide platform 10 so as to meet the needs of high accuracy and stability.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An air-bearing slide platform having a positioning module, the air-bearing slide platform comprising: at least one slide guide, a carrier mounted on the slide guide, at least one first air bearing provided between an upper surface of the slide guide and the carrier, and the positioning module provided on the slide platform, the air-bearing slide platform being characterized in that:
the positioning module includes a pair of ramps formed at two lower sides of the slide guide, and at least one second air bearing provided between two extended lower sides of the carrier and the ramps.

2. The air-bearing slide platform of claim 1, wherein the two ramps are symmetrical and mutually approaching.

3. The air-bearing slide platform of claim 1, wherein the carrier further includes a frame that spraddles on the slide guide.

4. The air-bearing slide platform of claim 1, wherein each of two connecting seats flanking the frame is for receiving a said second air bearing.

5. The air-bearing slide platform of claim 4, wherein each said connecting seat has an inclined portion matching the corresponding ramp, so that the second air bearing settled on the inclined portion corresponds to the ramp and is parallel to the corresponding ramp.
